(19) United States
(12) Patent Application Publication
(10) Pub. No.: US 2014/0125220 A1
(43) Pub. Date: May 8, 2014

(54) ILLUMINATION DEVICE

(71) Applicant: INDUSTRIAL TECHNOLOGY RESEARCH INSTITUTE, Hsinchu (TW)

(72) Inventors: Lung-Chang Liu, Hsinchu (TW); Po-Jen Yang, Hsinchu (TW); Ming-Hua Chung, Hsinchu (TW); Chien-Ming Chen, Hsinchu (TW)

(73) Assignee: Industrial Technology Research Institute, Hsinchu (TW)

(21) Appl. No.: 13/828,489

(22) Filed: Mar. 14, 2013

(30) Foreign Application Priority Data
Nov. 2, 2012 (TW) 101140672

(51) Int. Cl. C09K 11/06; H05B 33/12

(52) U.S. Cl. CPC C09K 11/06; H05B 33/12
USPC 313/504

(57) ABSTRACT

Provided is an illumination device including a semiconductor light source and an encapsulating agent. The semiconductor light source has an emission wavelength from 400 nm to 455 nm. The encapsulating layer includes an organic phosphor material. The organic phosphor material is used for the illumination device to meet the demand of industrial applicability.

### CROSS-REFERENCE TO RELATED APPLICATIONS

This application claims priority to Taiwanese Patent Application No. 101140672, filed on Nov. 2, 2012, which is incorporated by reference herein.

### TECHNICAL FIELD

The present invention relates to illumination devices, and more particularly, to an illumination device including a semiconductor light source and an organic phosphor material.

### BACKGROUND

A light emitting diode (LED) is a mercury-free and environmentally-friendly light source, and has the advantages such as low power consumption, a long service life, a high reaction rate, no thermal radiation and a small volume. In 1907, H. J. Round first discovered the phenomenon of electroluminescence of a semiconductor. In 1962, General Electric (GE), USA, successfully developed the first red light LED made from gallium arsenide phosphide (GaAsP), and the red LED was officially mass-produced four years later. Since then, LEDs had entered the commercialization phase. In 1991, Hewlett-Packard (the original LED department spun off from Hewlett-Packard as Lumileds, which was later acquired by Philips) cooperated with Toshiba to develop a quaternary compound (aluminum gallium indium phosphide, AlGaInP), which can emit red and amber lights with high brightness. This was the start of the era of high-brightness LEDs. In 1996, Nichia Corporation, Japan, first disclosed the technology of using a blue light LED in combination with Yttrium Aluminum Garnet (YAG) yellow phosphor powder to produce a white light, and later developed a white light LED, which became a novel light source that drew the most of the lighting industry's attention. Since then, white light LEDs officially entered the commercialization phase.

Because a white light LED has a long service life, a small volume, a low actuating voltage, low power consumption, a high reaction rate, no idling time, no mercury contamination and excellent shock resistance, it draws a wide attention in the recent years. White light LEDs are currently applied in mobile phones, digital cameras, car lights, traffic signals, street lamps, LED back light sources, interior lighting, etc. The components of the phosphor powder for use in a white light LED can be classified into two major categories: organic phosphor powder and inorganic phosphor powder. The common commercial phosphor powder for use in a white light LED is mainly made of inorganic materials. However, the process of making inorganic phosphor powder (such as YAG (Y₃Al₅O₁₂:Ce) and TAG (Terbium Aluminum Garnet; Tb₃Al₅O₁₂:Ce)) is performed at a high temperature (i.e., 800 to 2000° C.) and a high pressure (i.e., 1 to 10 atm), and the raw material used is a rare earth metal mine. Hence, the production of inorganic phosphor powder is not only energy-consuming, but also costly (i.e., an average selling price being 2,000 USD/kg; a worldwide demand being 50 tons/year (data source: Fuji Chimera), and an estimation of 80 to 100 tons/year by 2015). Moreover, the specific gravity of inorganic phosphor powder is large (i.e., about 4.5). When inorganic phosphor powder is mixed with an encapsulating glue, sedimentation unavoidably occurs, thereby reducing the service life of the manufactured LED. Further, an incompatibility issue exists between an inorganic material and an organic encapsulating glue, such that the optical properties are adversely affected by poor dispersibility of the inorganic material. Accordingly, there is a need to develop phosphor powder with industrial applicability for resolving the above conventional technical drawbacks while used in an LED

### SUMMARY

An illumination device includes a semiconductor light source having an emission wavelength from 400 nm to 455 nm; and an encapsulating layer encapsulating the semiconductor light source, wherein the encapsulating layer includes a phosphor material, and the phosphor material contains a compound of formula (I):

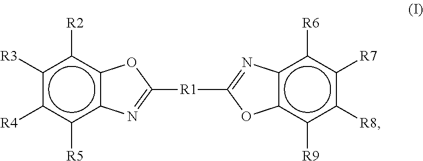

wherein R1 is

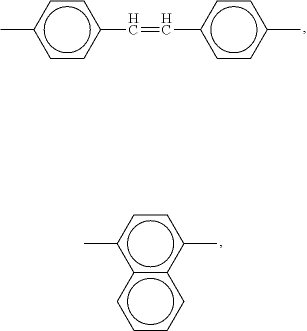

phenylene, —S—, vinylene,

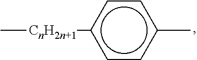

C₁₋₁₂ alkylene, —CₙH₂ₙ₊₁—O—, —CₙH₂ₙ(OH)— or C₁₋₁₂ cycloalkyleneoxy; R2, R3, R4, R5, R6, R7, R8 and R9 are independently hydrogen, phenyl,

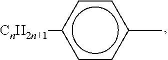

C₁₋₁₂ alkyl, CₙH₂ₙ₊₁—O—, HOCₙH₂ₙ₊₁— or CₙH₂ₙ₋₁—O—; and n is an integer of from 1 to 12.

According to one embodiment, R1 is

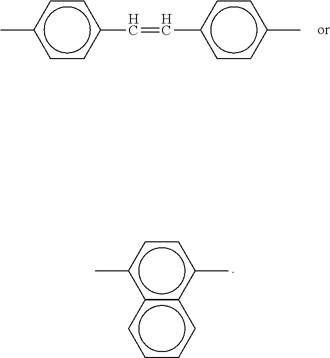

According to one embodiment, the compound of formula (I) is prepared by a heating method. In one example, the compound of formula (I) is prepared by using a heating method and a phosphoric acid-based dehydrating agent.

According to one embodiment, the semiconductor light source is an LED chip. In one example, the semiconductor light source is a blue light LED chip. In one example, the illumination device is a white illumination device.

According to one embodiment, the illumination device further includes a carrier and a transparent element, wherein the transparent element covers the semiconductor light source and the encapsulating layer. In one example, the encapsulating layer further includes an encapsulating material.

### BRIEF DESCRIPTION OF THE DRAWINGS

FIG. 1 is a schematic diagram of an illumination device according to one embodiment of the present disclosure;

FIG. 2 is an emission spectrum according to one embodiment of the present disclosure; and

FIG. 3 is an emission spectrum according to another embodiment of the present disclosure.

### DETAILED DESCRIPTION

In the following, specific embodiments are provided to illustrate the detailed description of the present disclosure. Those skilled in the art can conceive the other advantages and effects of the present disclosure, based on the specification. The present disclosure can also be practiced or applied by referring to the other different embodiments. Each of the details in the specification can also be modified or altered in various ways in view of different aspects and applications, without departing from the spirit of the creation of the present disclosure.

Unless otherwise noted, the terms “a” and “the” used in the specification and the appended claims, for specifying singular forms and also plural forms.

Unless otherwise noted, the term “or” used in the specification and the appended claim has the meaning of “and/or.”

An illumination device includes a semiconductor light source having an emission wavelength between 400 nm and 455 nm; and an encapsulating layer encapsulating the semiconductor light source, wherein the encapsulating layer includes a phosphor material, and the phosphor material contains a compound of formula (I):

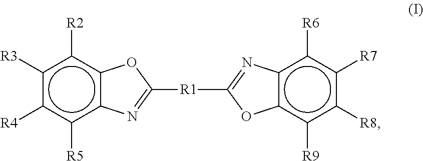

wherein R1 is

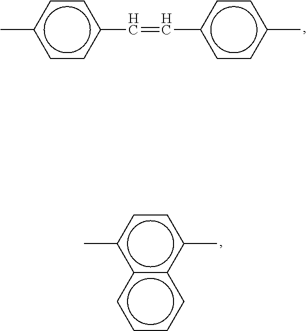

phenylene, —S—, vinylene,

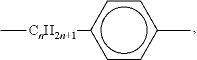

C₁₋₁₂ alkylene, —CₙH₂ₙ₊₁—O—, —CₙH₂ₙ(OH)— or C₁₋₁₂ cycloalkyleneoxy; R2, R3, R4, R5, R6, R7, R8 and R9 are independently hydrogen, phenyl,

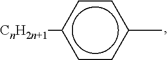

C₁₋₁₂ alkyl, CₙH₂ₙ₊₁—O—, HOCₙH₂ₙ₊₁— or CₙH₂ₙ₋₁—O—; and n is an integer of from 1 to 12.

According to one embodiment, in the above compound of formula (I), R1 is

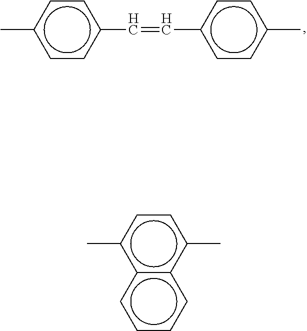

or phenylene, and is preferably

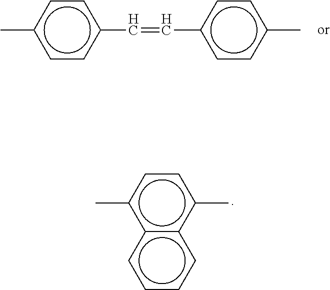

According to one embodiment, the compound of formula (I) is a compound of formula (I-1) below:

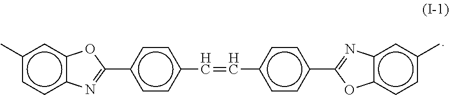

In one embodiment, the compound is used as a yellow phosphor material.

According to one embodiment, the above compound of formula (I) is a compound of formula (I-2) below:

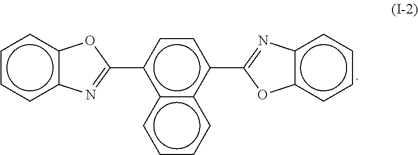

In one embodiment, the compound is used as a yellow phosphor material.

A compound of formula (I) can be synthesized by using a heating method or other conventional methods. When a compound of formula (I) is synthesized by using a heating method, the heating approach, and the heating device, temperature and time used can be optionally selected. Preferably, heating is performed at a temperature ranging from 0° C. to 200° C. Preferably, a compound of formula (I) is prepared by heating for 1 to 600 minutes.

Preferably, a compound of formula (I) is prepared by heating using microwave. For example, microwave from 50 W to 1000 W can be used for heating. According to one embodiment, when microwave is used to prepare a compound of formula (I) by heating, the compound of formula (I) is synthesized by heating at a temperature ranging from 0° C. to 40° C. for 1 to 600 minutes (preferably from 1 to 60 minutes, and more preferably from 1 to 30 minutes).

A dehydrating agent can be used in the preparation of the compound of formula (I). There are no special limitations to the type of the dehydrating agent. Preferably, a phosphoric acid-based dehydrating agent is used. The phosphoric acid-based dehydrating agent ay be, but not limited to, polyphosphoric acid, phosphorus pentoxide (P₂O₅), or an analogue thereof. One or more dehydrating agents can be used. Preferably, polyphosphoric acid and phosphorus pentoxide are used as dehydrating agents.

Detailed preparation methods are exemplified later in the examples. Compounds of formula (I) can also be prepared by using methods similar to those used in the examples. It is to be understood that the preparation method and the materials used for a compound of formula (I) of the present disclosure are not limited to the ones mentioned herein, and they can be optionally adjusted and modified as long as they can be used to synthesize the compound of formula (I).

The compounds of formula (I) can be used alone or in the form of a mixture. One or more compounds of formula (II) can be used as a phosphor material(s). The compounds of formula (I) can also be used in combinations with various other phosphor materials.

The phosphor material of the illumination device in the present disclosure includes a compound of formula (I). According to one embodiment, the compound of formula (I) can be used as the phosphor material of the illumination device of the present disclosure.

When a compound of formula (I) is used as the phosphor material of the illumination device, other additives may be optionally (for example, for modifying optical properties, etc.) added.

According to one embodiment, the specific gravity of the phosphor material used in the illumination device is from about 1 to 2, preferably from about 1.1 to 1.5, and more preferably from about 1.25 to 1.35. Preferably, a compound of formula (I) is used as the phosphor material of the illumination device in the present disclosure, and the specific gravity of the phosphor material is from about 1 to 2, preferably from about 1.1 to 1,5, and more preferably from about 1.25 to 1.35. More preferably, when a compound of formula (I) is used as the phosphor material of the illumination device in the present disclosure, the specific gravity of the phosphor material is from about 1 to 2, preferably from about 1.1 to 1.5, and more preferably from about 1.25 to 1.35.

When a compound of formula (I) is used as the phosphor material in the illumination device, the problem like sedimentation is resolved as the compound of formula (I) has a relatively lower specific gravity than those of the conventional phosphor materials. Further, the compatibility of the phosphor material and the encapsulating material can be increased, thereby avoiding the observed adverse effects of a conventional phosphor material on the optical properties and service life of an illumination device.

The encapsulating layer in the illumination device further includes an encapsulating material. The encapsulating material may be, but not limited to, acrylics, epoxy resins or silicones. One or more encapsulating materials can he used. The encapsulating material(s) may combine, in any forms, with the phosphor material to form an encapsulating layer of the illumination layer. According to one embodiment, the encapsulating layer can be formed by mixing the encapsulating material(s) and the phosphor material. The mixing ratio of the encapsulating material(s) to the phosphor material may be optionally selected. According to one embodiment, the amount of the phosphor material is from 5 wt % to 95 wt %, preferably from 10 wt % to 30 wt %, and more preferably from 15 wt % to 20 wt %, based on the total weight of the encapsulating material and the phosphor material, Preferably, when a compound of formula (I) is used as the phosphor material of the illumination device in the present disclosure, the amount of the phosphor material is from 5 wt % to 95 wt %, preferably from 10 wt % to 30 wt %, and more preferably from 15 wt % to 20 wt %, based on the total weight of the encapsulating material and the phosphor material. Preferably, when a compound of formula (I) is used as the phosphor material of the illumination device in the present disclosure, the amount of the phosphor material is from about 5 wt % to 95 wt %, preferably from 10 wt % to 30 wt %, and more preferably from 15 wt % to 20 wt %, based on the total weight of the encapsulating material and the phosphor material.

A semiconductor light source is used in the illumination device. The semiconductor light source is, but not limited to, an LED chip. The emission wavelength of the semiconductor light source of the illumination device is from 400 nm to 455 nm. An appropriate LED chip can be optionally selected. According to one embodiment, a blue light LED chip is used as a semiconductor light source. Preferably, an LED chip with a wavelength from 400 nm to 455 nm is used as the semiconductor light source. More preferably, a blue light LED chip with a wavelength from 400 nm to 455 nm is used as the semiconductor light source.

The illumination device further includes a carrier and a transparent element. The transparent element covers the semiconductor light source and the encapsulating layer. The materials used as the carrier and the transparent element can be optionally selected, without limitations. For example, without limitations, a leadframe can be used as a carrier for carrying the above semiconductor light source.

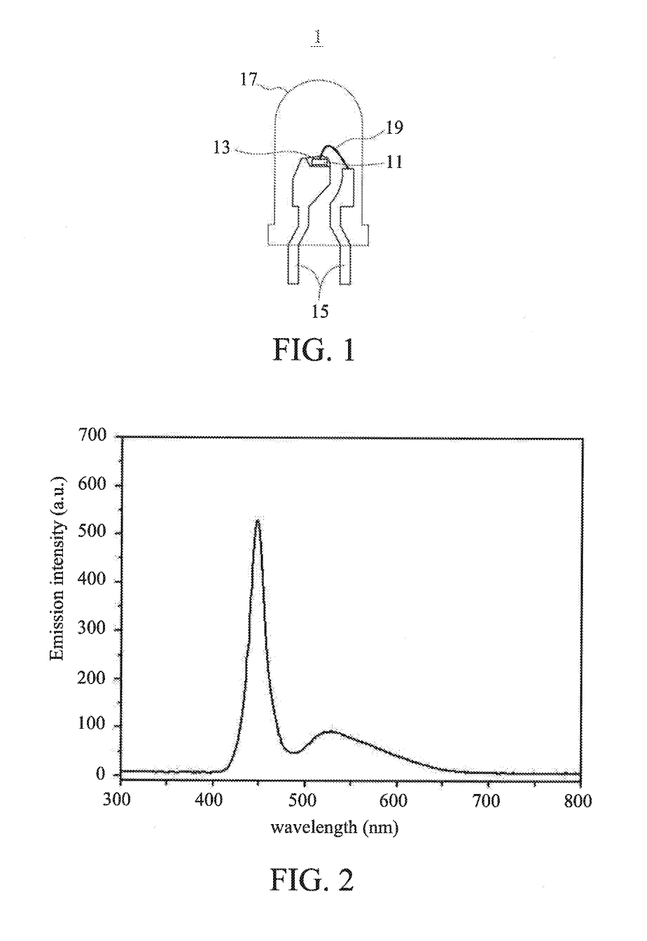

FIG. 1 is a schematic diagram of an illumination device according to one embodiment of the present disclosure. It is to be understood that an illumination device may not be limited to the one illustrated in FIG. 1, as long as it can achieve the purposes and effects of the illumination device of the present disclosure. An illumination device 1 includes a semiconductor light source 11, an encapsulating layer 13, a carrier 15, a transparent element 17 and a bonding wire 19. The semiconductor light source 11 is mounted on and electrically connected to the carrier 15. In one embodiment, the carrier 15 is a leadframe. The semiconductor light source 11 is an LED chip, preferably a blue light LED chip, and more preferably a blue light LED chip with a wavelength from 400 nm to 455 nm. The encapsulating layer 13 encapsulates the semiconductor light source 11. The encapsulating layer 13 includes an encapsulating material and a phosphor material. A compound including a compound of formula (I) is preferably used as the phosphor material, and a compound of formula (I) is more preferably used as the phosphor material. The encapsulating material(s) can combine, in any way, with the phosphor material, to form the encapsulating layer 13 of the illumination device 1. According to one embodiment, the encapsulating layer 13 of the illumination device 1 is prepared by mixing the encapsulating material(s) and the phosphor material. The mixing ratio of the encapsulating material(s) to the phosphor material can be optionally selected. According to one embodiment, the amount of the phosphor material is from 5 wt % to 95 wt %, preferably from 10 wt % to 30 wt %, and more preferably from 15 wt % to 20 wt %, based on the total weight of the encapsulating material and the phosphor material. The transparent element 17 covers the semiconductor light source 11 and the encapsulating layer 13. The transparent element 17 is optionally made of a suitable aterial. Moreover, the encapsulating material can be optionally used to fill the transparent element 17.

The semiconductor light source 11 emits primary radiation, which passes through the encapsulating layer 13 containing the encapsulating material(s) and the phosphor material and disposed in the surrounding the semiconductor light source 11. The encapsulating layer 13 can convert at least a portion of the radiation emitted by the semiconductor light source 11 into secondary radiation. According to one embodiment, the illumination device 1 is a white light illumination device, which uses an LED chip with an emission wavelength from 400 nm to 455 nm as the semiconductor light source 11, and the phosphor material in the encapsulating layer 13 allows the illumination device 1 to emit a white light. The phosphor material of the illumination device 1 includes the compound of formula (I). According to an embodiment, the compound of formula (I) is used as the phosphor material of the illumination device 1.

As compared with the commercial illumination devices using inorganic phosphor powder, the illumination device of the present disclosure uses a compound of formula (I) as the phosphor material. Because the specific gravity of the compound of formula (I) is lower, a problem like sedimentation is avoided and the compatibility of the phosphor material and the encapsulating material is increased. Moreover, as compared with the illumination devices using inorganic phosphor powder, the white light emitted by the illumination device of the present disclosure is softer, and no halo and glare are generated. Thus, the illumination device of the present disclosure can avoid the drawbacks of the conventional illumination devices. Further, from the aspects of fabrication and cost, the illumination device of the present disclosure very much meets the demand of industrial applicability.

The present disclosure will be more specifically described by the examples. However, these examples are not intended to limit the scope of the present disclosure. Unless otherwise specified, “%” and “part(s)” used in the following examples and comparative examples for expressing the amount of any component, and if any, the amount of any substance for are based on weights.

### EXAMPLES

### Example 1

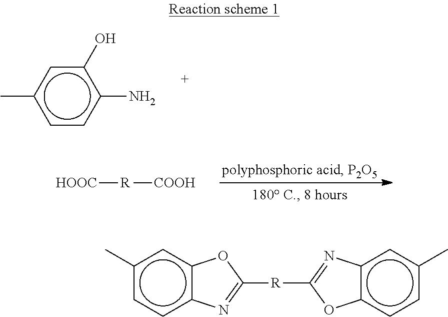

(In the reaction scheme 1, R is

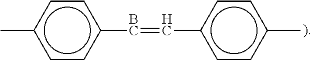

2-amino-5-methyl-phenol (61.5 g, 0.5 mol), stilbene-4,4-dicarboxylic acid (45.0 g, 0.25 mol), polyphosphoric acid (30 g) and P₂O₅ (10 g) were placed in a reaction flask, heated to 180° C. and stirred for 8 hours. After cooling, n-hexane was added for recrystallization. Then, filtration and washing with methanol were performed, and 64.2 g of a compound of formula (I-1) (yield: 62%) was obtained. The aforesaid reaction is shown in reaction scheme 1, and the structure of the product is identified as follows.

¹H NMR (400 MHz, TFA-d₁, ppm): 2.56 (s, 6H), 7.51-7.61 (m, 4H), 7.72-7.77 (m, 4H), 7.90-7.94 (m, 4H), 8.32-8.17 (m, 4H).

FT-IR (KBr): 3050 cm⁻¹ (aromatic C—H stretching), 1617 cm⁻¹ (C═C) stretching), 1610 cm⁻¹ (C═N stretching), 1580 cm⁻¹ (aromatic ring mode), 1500 cm⁻¹ (aromatic ring mode), 1450 cm⁻¹ (aromatic ring mode), 1240 cm⁻¹ (C—O stretching), 743 cm⁻¹ (aromatic out-of-plane C—H bend).

MS:(m/z) (FAB⁺) 443;

Elemental analysis (C₃₀H₂₂N₂O₂) Theoretical value: C, 81.43; H, 5.01; N, 6.33.

Experimental value: C, 81.39; H,5.01; N, 6.46.

### Example 2

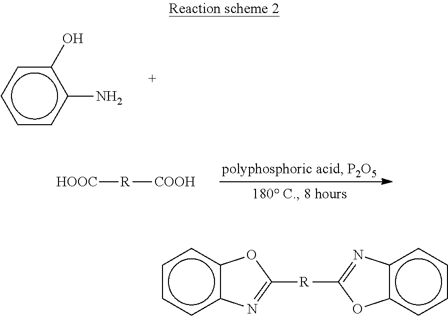

(In the reaction scheme 2, R is

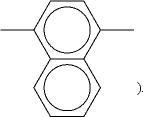

2-aminphenol (54.5 g, 0.5 mol), naphathalene-4,4-dicarboxylic acid (54.1 g, 0.25 mol), polyphosphoric acid (30 g) and P₂O₅ (10 g) were placed in a reaction flask, heated to 180° C. and stirred for 8 hours. After cooling, n-hexane was added for recrystallization. Then, filtration and washing with methanol were performed, and 58.9 g of a compound of formula (I-2) (yield: 65%) was obtained. The aforesaid reaction is shown in reaction scheme 2, and the structure of the product is identified as follows.

¹H NMR (400 MHz, DMSO-d₆, ppm): 7.52-7.54 (m, 4H), 7.91-7.99 (m, 6H), 8.643 (d, 2H), 9.63 (d, 2H).

FT-IR (KBr): 3040 cm⁻¹ (aromatic C—H stretching), 1610 cm⁻¹ (C═N stretching), 1530 cm⁻¹ (aromatic ring mode), 1450 cm⁻¹ (aromatic ring mode), 1240 cm⁻¹ (C—O stretching), 743 cm⁻¹ (aromatic out-of-plane C—H bend).

MS:(m/z) (FAB⁺) 363;

Elemental analysis (C₂₄H₁₄N₂O₂) Theoretical value: C, 79.55; H, 3.89; N, 7.73.

Experimental value: C, 79.23; H, 4,11; N, 7.83.

### Example 3

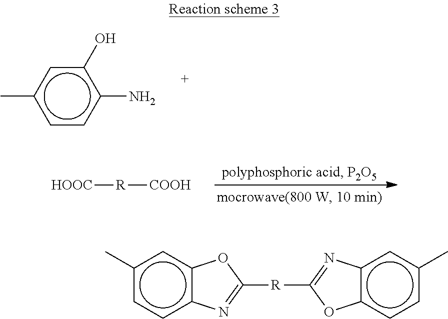

(In the reaction scheme 3, R is

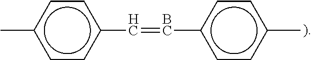

2-amino-5-methyl-phenol (61.5 g, 0.5 mol), stilbene-4,4-dicarboxylic acid (45.0 g, 0.25 mol), polyphosphoric acid (30 g) and P₂O₅ (10 g) were placed in a microwave reactor (which has a power of about 800 W) for heating by microwave for 10 minutes. After g, n-hexane was added for recrystallization. Then, filtration and washing with methanol were performed, and 95.2 g of a compound of formula (I-1) (yield: 86%) was obtained. The aforesaid reaction is shown in reaction scheme 3, and the physical properties of the product are shown in Table 1. The structure of the product is identified as follows.

¹H NMR (400 MHz, TFA-d₁, ppm): 2.56 (s, 6H), 7.51-7.61 (m, 4H), 7.72-7.77 (m, 4H), 7.90-7.94 (m, 4H), 8.32-8.17 (m, 4H).

FT-IR (KBr): 3051 cm⁻¹ (aromatic C—H stretching), 1615 cm⁻¹ (C═C) stretching), 1608 cm⁻¹ (C═N stretching), 1582 cm⁻¹ (aromatic ring mode), 1503 cm⁻¹ (aromatic ring mode), 1448 cm⁻¹ (aromatic ring mode), 1243 cm⁻¹ (C—O stretching), 741 cm⁻¹ (aromatic out-of-plane C—H bend).

MS:(m/z) (FAB⁺) 443;

Elemental analysis (C₃₀H₂₂N₂O₂) Theoretical value: C, 81.43; H, 5.01; N, 6.33.

Experimental value: C, 81.38; H, 4.95; N, 6.41.

### Example 4

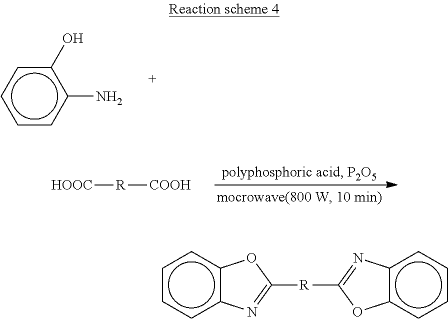

(In the reaction scheme 4, R is

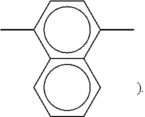

2-aminophenol (54.5 g, 0.5 mol), naphthalene-4,4-dicarboxylic acid (54.1 g, 0.25 mol), polyphosphoric acid (30 g) and P₂O₅ (10 g) were placed in a microwave reactor (which has a power of about 800 W) for heating by microwave for 10 minutes. After cooling, n-hexane was added for recrystallization. Then, filtration and washing with methanol were performed, and 82.5 g of a compound of formula (1-2) (yield: 91%) was obtained. The aforesaid reaction is shown in reaction scheme 4, and the physical properties of the product are shown in Table 1. The structure of the product is identified as follows.

¹H NMR (400 MHz, DMSO-d₆, ppm): 7.52-7.54 (m, 4H), 7.91-7.99 (m, 6H), 8.643 (d, 2H), 9.63 (d, 2H).

FT-IR (KBr): 3043 cm⁻¹(aromatic C—H stretching), 1612 cm⁻¹ (C═N stretching), 1527 cm⁻¹ (aromatic ring mode), 1451 cm⁻¹ aromatic ring mode), 1240 cm⁻¹ (C—O stretching), 740 cm⁻¹ (aromatic out-of-plane C—H bend).

MS:(m/z) (FAB⁺) 363;

Elemental analysis (C₂₄H₁₄N₂O₂) Theoretical value: C, 79.55; H, 3.89; N, 7.73.

Experimental value: C, 79.61; H,3.95; N, 7.82.

The physical properties (including specific gravity, thermal degradation temperatures (Td), emission wavelengths, and quantum yields) of the products prepared in Examples 1 and 3, and Examples 2 and 4 are shown in Table 1.

TABLE 1
Physical properties of the phosphor materials

| | | Thermal | | |
|---|---|---|---|---|
| | | degradation | Emission | |
| | Specific | temperatures | wavelength | Quantum |
| Phosphor material | gravity | (° C.) | λₘₐₓ (nm) | efficiency |
| Examples 1 and 3 | 1.29 | 330 | 537* | 0.82 |
| Examples 2 and 4 | 1.35 | 374 | 518* | 0.88 |

*Excitation at 400 nm

It is known from Table 1 that as compared with the conventional phosphor materials, the phosphor material of the present disclosure has lower specific gravity. This not only resolves the problem like sedimentation, but also increases the compatibility of a phosphor material and an encapsulating material. Further, the phosphor material of the present disclosure also has high thermal stability, an appropriate emission wavelength and a high quantum yield,

### Comparative Example 1

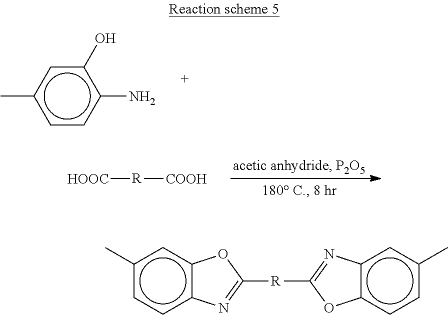

(In the reaction scheme 5, R is

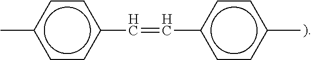

2-amino-5-methyl-phenol (61.5 g, 0.5mol), stilbene-4,4-dicarboxylic acid (45.0 g, 0.25 mol) and acetic anhydride (30 g) were placed in a reaction flask, heated to 180° C. and stirred for 8 hours. After cooling, n-hexane was added for recrystallization. Then, filtration and washing with methanol were performed, and 46.6 g of a compound of formula (I-1) (yield: 45%) was obtained. The aforesaid reaction is shown in reaction scheme 5, and the structure of the product is identified as follows.

¹H NMR (400 MHz, TFA-d₁, ppm): 2.56 (s, 6H), 7.51-7.61 (m, 4H), 7.72-7.77 (m, 4H), 7.90-7.94 (m, 4H), 8.32-8.17 (m, 4H).

FT-IR (KBr): 3048 cm⁻¹ (aromatic C—H stretching), 1619 cm⁻¹ (C═C) stretching), 1611 cm⁻¹ (C═N stretching), 1582 cm⁻¹ (aromatic ring mode), 1503 cm⁻¹ (aromatic ring mode), 1449 cm⁻¹ (aromatic ring mode), 1237 cm⁻¹ (C—O stretching), 741 cm⁻¹ (aromatic out-of-plane C—H bend).

MS:(m/z) (FAB⁺) 443;

Elemental analysis (C₃₀H₂₂N₂O₂) Theoretical value: C, 81.43; H, 5.01; N, 6.33.

Experimental C, 81.29; H, 5.05; N, 6.46.

### Comparative Example 2

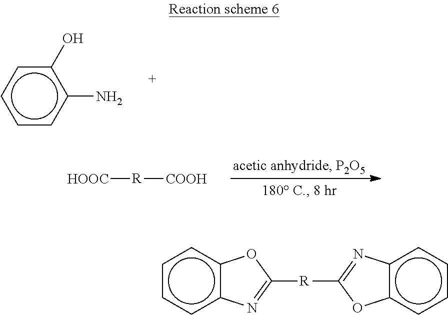

(In the reaction scheme 6, R is

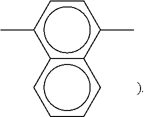

2-aminophenol (54.5 g, 0.5 mol), naphthalene-4,4-dicarboxylic acid (54.1 g, 0.25 mol) and acetic anhydride (30 g) were placed in a reaction flask, heated to 180° C. and stirred for 8 hours. After cooling, n-hexane was added for recrystallization. Then, filtration and washing with methanol were performed, and 42.6 g of a compound of formula (I-2) (yield: 47%) was obtained. The aforesaid reaction is shown in reaction scheme 6, and the structure of the product is identified as follows.

¹H NMR (400 MHz, DMSO-d₆, ppm): 7.52-7.54 (m, 4H), 7.91-7.99 (m, 6H), 8.643 (d, 2H), 9.63 (d, 2H).

FT-IR (KBr): 3037 cm⁻¹ (aromatic C—H stretching), 1608 cm⁻¹ (C═N stretching), 1533 cm⁻¹ (aromatic ring mode), 1452 cm⁻¹ (aromatic ring mode), 1242 cm⁻¹ (C—O stretching), 747 cm⁻¹(aromatic out-of-plane C—H bend). MS:(m/z) (FAB⁺) 363;

Elemental analysis (C₂₄H₁₄N₂O₂) Theoretical value: C, 79.55; H, 3.89; N, 7.73.

Experimental value: C, 79.46; H, 4.02; N, 7.61.

As compared with Comparative Examples 1 and 2 where acetic anhydride was used as the dehydrating agents, higher yields were obtained in Examples 1, 2, 3 and 4 where polyphosphoric acid and P₂O₅ were used the dehydrating agents.

Moreover, as compared with in Examples 1 and 2, the compounds of formula (I) prepared using microwaves in Examples 3 and 4 had better reaction rates and yields.

### Example 5

The phosphor powder prepared in Example 3 was blended in an SR 7010 encapsulating material (manufactured by Dow Coring Co.) (at a weight ratio of phosphor powder:encapsulating material=18:82.). Then, the blended material was poured onto a frame (i.e., a carrier) on which a blue light chip (GaInN, with an emission wavelength of 430 nm, 0.015 inch², and manufactured by I-Chiun Precision Industry Co., Taiwan) was mounted, wherein the blue light chip (i.e., a semiconductor light source) was connected to another part of the frame via a bonding wire. The blended material was then heated at 120° C. for 3 hours to cure. Then, the encapsulating material disposed with the blue light chip and the phosphor powder was placed into a round-type transparent casing (i.e., transparent element). Subsequently, the interior of the round-type casing was filled with the SR 7010 encapsulating material, and the casing was heated at 120° C. for 3 hours to cure the encapsulating material, so as to form a round-type illumination device shown in FIG. 1. The round-type LED device in the Example could emit a white light (with color coordinates of CIE_{x,y}=(0.35,0.34)) in the direction away from the frame, and the emission spectrum of the white light is shown in FIG. 2.

### Example 6

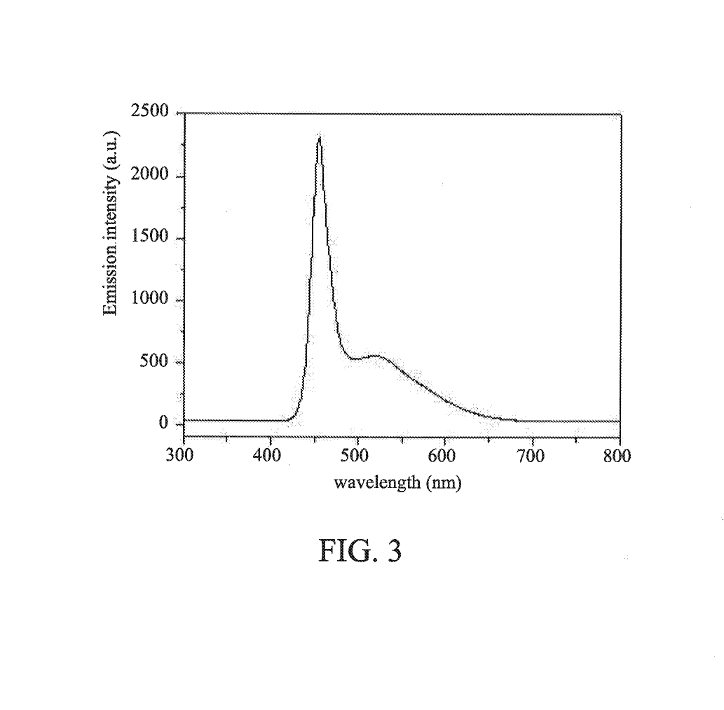

The phosphor powder prepared in example 4 was blended in an SR 7010 encapsulating material (manufactured by Dow Coring Co.) (at a weight ratio of phosphor powder:encapsulating material=18:82). Then, the blended material was poured onto a frame on which a blue light chip (GaInN, with an emission wavelength of 430 nm, 0.015 inch², and manufactured by I-Chiun Precision Industry Co., Taiwan) was mounted, wherein the blue light chip was connected to another part of the frame via a bonding wire. The blended material was then heated at 120° C. for 3 hours to cure. Then, the encapsulating material disposed with the blue light chip and the phosphor powder was placed into a round-type transparent casing (i.e., the transparent element 17). Subsequently, the interior of the round-type casing was filled with the SR 7010 encapsulating material, and the casing was heated at 120° C. for 3 hours to cure the encapsulating material, so as to obtain a round-type illumination device shown in FIG. 1. The round-type LED device in the Example could emit a white light (with color coordinates of CIE_{x,y}=(0.25,0.24)) in the direction away from the frame, and the emission spectrum of the white light is shown in FIG. 3.

### Comparative Example 3

The phosphor powder prepared in Example 3 was blended in an SR 7010 encapsulating material (manufactured by Dow Coring Co.) (at a weight ratio of phosphor powder:encapsulating material=18:82). Then, the blended material was poured onto a frame on which a blue light chip (with an emission wavelength of 470 nm, 0.015 inch², and manufactured by I-Chiun Precision Industry Co., Taiwan) was mounted, wherein the blue light chip was connected to another part of the frame via a bonding wire. The blended material was then heated at 120° C. for 3 hours to cure. Then, the encapsulating material disposed with the blue light chip and the phosphor powder was placed into a round-type transparent casing. Subsequently, the interior of the round-type casing was filled with the SR 7010 encapsulating material, and the casing was heated at 120° C. for 3 hours to cure the encapsulating material, so as to obtain a round-type illumination device shown in FIG. 1. The obtained round-type LED device emitted a blue light (with an emission wavelength of 470 nm) rather than a white light.

### Comparative Example 4

The phosphor powder prepared in Example 3 was blended in an SR 7010 encapsulating material (manufactured by Dow Coring Co.) (at a weight ratio of phosphor powder:encapsulating material=18:82). Then, the blended material was poured onto a frame on which a blue light chip (with an emission wavelength of 460 nm, 0.015 inch², and manufactured by I-Chiun Precision Industry Co., Taiwan) was mounted, wherein the blue light chip was connected to another part of the frame via a bonding wire. The blended material was then heated at 120° C. for 3 hours to cure. Then, the encapsulating material disposed with the blue light chip and the phosphor powder was placed into a round-type transparent casing. Subsequently, the interior of the round-type casing was filled with the SR 7010 encapsulating material, and the casing was heated at 120° C. for 3 hours to cure the encapsulating material, so as to form a round-type illumination device shown in FIG. 1. The obtained round-type LED device emitted a blue light (with an emission wavelength of 460 nm) rather than a white light.

### Example 7

The phosphor powder prepared in Example 3 was blended in an SR 7010 encapsulating material (manufactured by Dow Coring Co.) (at a weight ratio of phosphor powder:encapsulating material=18:82). Then, the blended material was poured onto a frame on which a blue light chip (with an emission wavelength of 455 nm, 0.015 inch², and manufactured by I-Chiun Precision industry Co., Taiwan) was disposed, wherein the blue light chip was connected to another part of the frame via a bonding wire. The blended material was then heated at 120° C. for 3 hours to cure. Then, the encapsulating material disposed with the blue light chip and the phosphor powder was placed into a round-type transparent casing. Subsequently, the interior of the round-type casing was filled with the SR 7010 encapsulating material, and the casing was heated at 120° C. for 3 hours to cure the encapsulating material, so a to form a round-type illumination device shown in FIG. 1. The round-type LED device in this Example emitted a weak, bluish white light in the direction away from the frame, as observed by a visual observation.

### Example 8

The phosphor powder prepared in Example 3 was blended in an SR 7010 encapsulating material (manufactured by Dow Coring Co.) (at a weight ratio of phosphor powder:encapsulating material=18:82), Then, the blended material was poured onto a frame on which a blue light chip (with an emission wavelength of 400 nm, 0.015 inch², and manufactured by I-Chiun Precision Industry Co., Taiwan) was mounted, wherein the blue light chip was connected to another part of the frame via a bonding wire. The blended material was heated at 120° C. for 3 hours to cure. Then, the encapsulating material disposed with the blue light chip and the phosphor powder was placed into a round-type transparent casing. Subsequently, the interior of the round-type easing was filled with the SR 7010 encapsulating material, and the casing was heated at 120° C. for 3 hours to cure the encapsulating material, so as to form a round-type illumination device shown in FIG. 1. The round-type LED device in this Example emitted a weak white light in the direction away from the frame, as observed by a visual observation.

### Example 9

The phosphor powder prepared in Example 3 was blended in an SR 7010 encapsulating material (manufactured by Dow Coring Co.) (at a weight ratio of phosphor powder:encapsulating material=5:95). Then, the blended material was poured onto a frame on which a blue light chip (with an emission wavelength of 430 nm, 0.015 inch², and manufactured by I-Chiun Precision Industry Co., Taiwan) was mounted, wherein the blue light chip was connected to another part of the frame via a bonding wire. The blended material was then heated at 120° C. for 3 hours to cure. Then, the encapsulating material disposed with the blue light chip and the phosphor powder was placed into a round-type transparent casing. Subsequently, the interior of the round-type casing was filled with the SR 7010 encapsulating material, and the casing was heated at 120° C. for 3 hours to cure the encapsulating material, so as to form a round-type illumination device shown in FIG. 1. The round-type LED device in this Example emitted a weak, bluish white light in the direction away from the frame, as observed by a visual observation.

### Comparative Example 5

The phosphor powder prepared in Example 3 was blended in an SR 7010 encapsulating material (manufactured by Dow Coring Co.) (at a weight ratio of phosphor powder:encapsulating material=18:82). Then, the blended material was poured onto a frame on which a blue light chip (with an emission wavelength of 390 nm, 0.015 inch², and manufactured by I-Chiun Precision Industry Co., Taiwan) was mounted, wherein the blue light chip was connected to another part of the frame via a bonding wire. The blended material was then heated at 120° C. for 3 hours to cure. Then, the encapsulating material disposed with the blue light chip and the phosphor powder was placed into a round-type transparent casing. Subsequently, the interior of the round-type casing was filled with the SR 7010 encapsulating material, and the casing was heated at 120° C. for 3 hours to cure the encapsulating material, so as to form a round-type illumination device shown in FIG 1. The obtained round-type LED device could not emit a light.

### Comparative Example 6

The phosphor powder prepared in Example 3 was blended in an SR 7010 encapsulating material (manufactured by Dow Coring Co.) (at a weight ratio of phosphor powder:encapsulating material=1:99). Then, the blended material was poured onto a frame on which a blue light chip (with an emission wavelength of 430 nm, 0.015 inch², and manufactured by I-Chiun Precision Industry Co., Taiwan) was mounted, wherein the blue light chip was connected to another part of the frame via a bonding wire. The blended material was then heated at 120° C. for 3 hours to cure. Then, the encapsulating material disposed with the blue light chip and the phosphor powder was placed into a round-type transparent casing. Subsequently, the interior of the round-type casing was filled with the SR 7010 encapsulating material, and the casing was heated at 120° C. for 3 hours to cure the encapsulating material, so as to form a round-type illumination device shown in FIG. 1. The round-type LED device emitted a blue light rather than a white light.

### Comparative Example 7

The phosphor powder prepared in Example 3 was blended in an SR 7010 encapsulating material (manufactured by Dow Coring Co.) (at a weight ratio of phosphor powder:encapsulating material=3:97). Then, the blended material was poured onto a frame on which a blue light chip (with an emission wavelength of 430 nm, 0.015 inch², and manufactured by I-Chiun Precision Industry Co., Taiwan) was mounted, wherein the blue light chip was connected to another part of the frame via a bonding wire. The blended material was heated at 120° C. for 3 hours to cure. Then, the encapsulating material disposed with the blue light chip and the phosphor powder was placed into a round-type transparent casing. Subsequently, the interior of the round-type casing was filled with the SR 7010 encapsulating material, and the easing was heated at 120° C. for 3 hours to cure the encapsulating material, so as to form a round-type illumination device shown in FIG. 1. The round-type LED device emitted a blue light rather than a white light.

As compared with the devices in Comparative Examples 3 to 5 which could emit a white light or could not emit a light, the illumination devices shown in Examples 5 to 9 each used a semiconductor light source from 400 mu to 455 nm in a combination with a compound of formula (I) as a phosphor material, and could emit a white light. Further, as shown in Comparative Examples 6 and 7, the devices using insufficient amounts of the phosphor materials could not emit a white light.

The white light emitted by the illumination device of the present disclosure is softer than that emitted by an illumination device encapsulated with inorganic phosphor powder. Further, the light emitted by the illumination device of the present disclosure does not generate a halo or glare, such that the drawbacks of a conventional illumination device encapsulated with inorganic phosphor powder are avoided. Moreover, the illumination device of the present disclosure also has excellent quantum yield, initial luminance, and service life, indicating that it has industrial applicability.

A conventional illumination device, which uses inorganic phosphor powder, has a shortened service life, because sedimentation inevitably occurs when the inorganic phosphor powder, which has large specific gravity, is mixed with an encapsulating gel. Further, an incompatibility issue exists between the inorganic material and the organic encapsulating gel, such that the optical properties of the illumination device are adversely affected due to poor dispersibility of the inorganic material. Moreover, inorganic phosphor powder needs a high temperature, high pressure process and a rare earth metal mine as a raw material, such that the production of inorganic phosphor powder is not Only energy-consuming, but also costly.

On the contrary, the illumination device of the present disclosure uses a compound of formula (I) as a phosphor material. Because the phosphor material has lower specific gravity than inorganic phosphor, the problem like sedimentation is resolved, and the compatibility of the phosphor material and the encapsulating material is increased. Further, as compared with conventional phosphor powder, which needs a high temperature and high pressure process and uses an expensive raw material, the phosphor material used in the illumination device of the present disclosure very much meets the demand of industrial applicability. Moreover, a substantially high yield is achieved by using a phosphoric acid-based dehydrating agent (such as polyphosphoric acid and P₂O₅) as the dehydrating agent to prepare the phosphor material of the illumination device of the present disclosure. In addition, excellent reaction rates and yields are further exhibited by using microwave to prepare the phosphor powder.

The above examples are only used to exemplify the illumination device and the preparation thereof, and should not be construed as to limit the present disclosure. The above examples can be modified and altered by those with ordinary skill in the art, without departing from the spirit and scope of the present disclosure as defined in the following appended claims.

1. An illumination device, comprising:
a semiconductor light source having an emission wavelength of from 400 nm to 455 nm; and
an encapsulating layer encapsulating the semiconductor light source, and comprising a phosphor material containing a compound of formula (I): 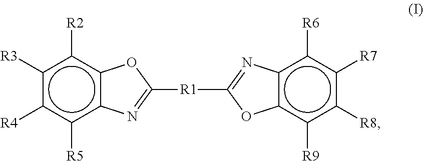
wherein R1 is one selected from the group consisting of 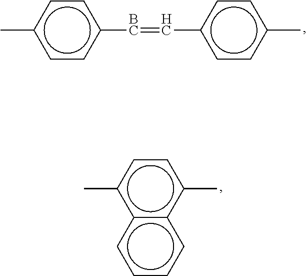
phenylene, —S—, vinylene, 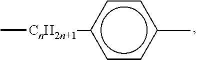
C₁₋₁₂alkylene, —CₙH₂ₙ₊₁—O—, —CₙH₂ₙ(OH)— and C₁₋₁₂cycloalkyleneoxy; R2, R3, R4, R5, R6, R7, R8 and R9 are independently selected from the group consisting of hydrogen, phenyl, 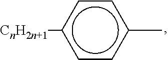
C₁₋₁₂alkyl, CₙH₂ₙ₊₁—O—, HOCₙH₂ₙ₊₁— and CₙH₂ₙ₊₁—O—; and n is an integer from of 1 to 12.

2. The illumination device of claim 1, wherein the semiconductor light source is a light-emitting diode chip.

3. The illumination device of claim 2, wherein the semiconductor light source is a blue light light-emitting diode chip.

4. The illumination device of claim 1, wherein the phosphor material has specific gravity from about 1 to 2.

5. The illumination device of claim 4, wherein the phosphor material has specific gravity from about 1.1 to 1.5.

6. The illumination device of claim 1, wherein R1 is one selected from the group consisting of 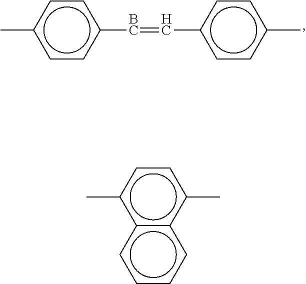
and phenylene.

7. The illumination device of claim 1, wherein R1 is one of

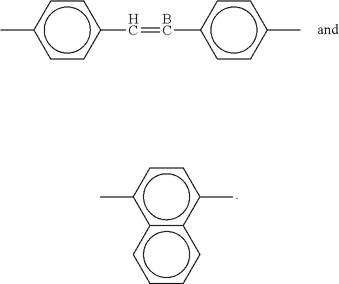

8. The illumination device of claim 1, being a white light illumination device.

9. The illumination device of claim 1, wherein the compound of formula (I) is prepared by heating.

10. The illumination device of claim 9, wherein the compound of formula (I) is prepared by using microwave.

11. The illumination device of claim 9, wherein the compound of formula (I) is prepared by using a phosphoric acid-based dehydrating agent.

12. The illumination device of claim 11, wherein the phosphoric acid-based dehydrating agent is one selected from the group consisting of polyphosphoric acid, phosphorus pentoxide and a combination thereof.

13. The illumination device of claim 1, wherein the encapsulating layer further comprises an encapsulating material.

14. The illumination device of claim 13, wherein the encapsulating layer is prepared by mixing the encapsulating material and the phosphor material.

15. The illumination device, of claim 14, wherein the phosphor material is in an amount from 5 wt % to 95 wt %, based on a total weight of the encapsulating material and the phosphor material.

16. The illumination device of claim 1, further comprising a carrier and a transparent element, wherein the transparent element covers the semiconductor light source and the encapsulating layer.

17. The illumination device of claim 16, wherein the carrier is a leadframe.
